(19) United States
(12) Patent Application Publication
(10) Pub. No.: US 2015/0088331 A1
(43) Pub. Date: Mar. 26, 2015

(54) INTELLIGENT WALL PLUG

(71) Applicant: Fibar Group sp. z o.o., Poznan (PL)

(72) Inventors: Maciej Fiedler, Poznan (PL); Bartlomiej Arcichowski, Poznan (PL); Robert Zdunek, Wrzesnia (PL)

(21) Appl. No.: 14/494,753

(22) Filed: Sep. 24, 2014

Related U.S. Application Data
(60) Provisional application No. 61/881,793, filed on Sep. 24, 2013.

(51) Int. Cl. H04L 12/28; G05F 1/66

(52) U.S. Cl. CPC H04L 12/2803; G05F 1/66; H04L 2012/2843; H04L 41/0226
USPC 700/295

(57) ABSTRACT

An intelligent wall plug being removably connectable to an electrical outlet and for use with a remote wireless manager configured to communicate via a first communication protocol. The intelligent wall plug includes a device receptacle to receive a device operable to communicate in a second communication protocol. The intelligent wall plug also includes a processor coupled to the device receptacle to receive control signals from the remote wireless manager via the first communication protocol, to determine if a device has been connected to the device receptacle, and, in response to having determined that a device having been connected to the device receptacle, to translate the first communication protocol into the second communication protocol, and to control the device with the communicated control signals.

### CLAIM OF PRIORITY/INCORPORATION BY REFERENCE

This patent application makes reference to, claims priority to and claims benefit from U.S. Provisional Patent Application Ser. No. 61/881,793 entitled “Intelligent Wall Plug” filed on Sep. 24, 2013, which is hereby incorporated herein by reference in its entirety.

### TECHNICAL FIELD

Aspects of the present disclosure relate to electronic systems and/or networking More specifically, certain implementations of the present disclosure relate to an intelligent wall plug.

### BACKGROUND

Existing methods and systems for providing device control can be costly, cumbersome and inefficient. Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for an intelligent wall plug, substantially as shown in and/or described in connection with at least one of the figures, as set forth more completely in the disclosure and/or the claims.

These and other advantages, aspects and novel features of the present disclosure, as well as details of illustrated implementation(s) thereof, will be more fully understood from the following description and drawings.

### BRIEF DESCRIPTION OF SEVERAL VIEWS OF THE DRAWINGS

FIG. 1 illustrates an example home network.

FIG. 2 illustrates an example intelligent wall plug.

FIG. 3 illustrates an example flow chart of a method for an example process for managing one or more intelligent wall plugs.

FIG. 4 illustrates an example intelligent control system.

### DETAILED DESCRIPTION

Certain implementations may be found in a method and system for an intelligent wall plug. In one embodiment, the invention provides an intelligent wall plug being removably connectable to an electrical outlet and for use with a remote wireless manager to communicate via a first communication protocol. The intelligent wall plug includes a device receptacle to receive a device operable to communicate in a second communication protocol. The intelligent wall plug also includes a processor coupled to the device receptacle, and to receive control signals from the remote wireless manager via said first communication protocol, to determine if a device has been connected to said device receptacle, and, in response to having determined that a device having been connected to the device receptacle, to translate the first communication protocol into the second communication protocol, and to control the device with the communicated control signals.

In one embodiment, the invention provides an intelligent control system for use with an electrical outlet. The system includes a device to communicate in a first communication protocol, a home network manager to communicate control signals to the device via a second communication protocol, and an intelligent wall plug being removably connectable to the electrical outlet. The intelligent wall plug includes a) a receptacle, b) a processor configured to receive the control signal via the second communication protocol, and c) a translator, in response to said device having been connected to the receptacle, to i) translate said second communication protocol into the first communication protocol, and ii) communicate the control signals to the connected device via the first communication protocol to control the device.

In one embodiment, the invention provides a method of controlling a remote device via an intelligent wall plug being removably connectable to an electrical outlet. The remote device may communicate in a first communication protocol with a home network manager that may communicate control signals via a second communication protocol. The method includes determining if the remote device has been connected to the intelligent wall plug. The method also includes translating, in response to the device having been connected to the intelligent wall plug, the second communication protocol into the first communication protocol, communicating the control signals to the connected remote device via the first communication protocol, and controlling the connected remote device with the control signals.

As utilized herein the terms “circuits” and “circuitry” refer to physical electronic components (i.e. hardware) and any software and/or firmware (“code”) which may configure the hardware, be executed by the hardware, and/or otherwise be associated with the hardware. As used herein, for example, a particular processor and memory may comprise a first “circuit” when executing a first plurality of lines of code and may comprise a second “circuit” when executing a second plurality of lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and/or “module” refer to functions than may be performed by one or more circuits. As utilized herein, the term “example” means serving as a non-limiting example, instance, or illustration. As utilized herein, the terms “for example” and “e.g.” introduce a list of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

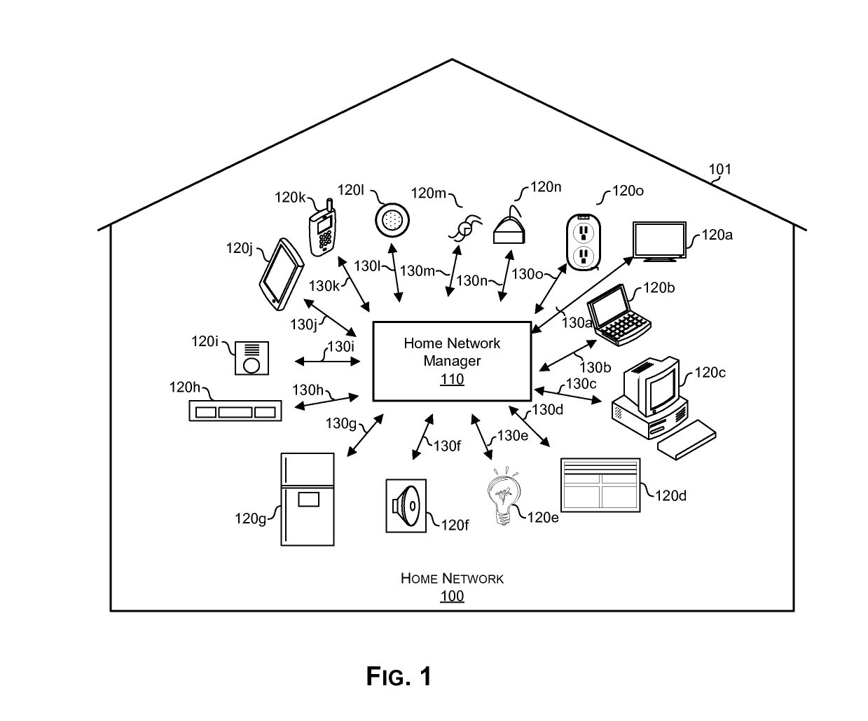

FIG. 1 illustrates an example home network. Referring to FIG. 1, there is shown a home network 100.

The home network 100 may correspond to a location 101. The location 101 may, for example, correspond to a residence (e.g., home, apartment) or non-residence premises (e.g., small business, school, library, factory, or the like). In this regard, the home network 100 may, for example, comprise a plurality of home network elements, such as, for example, a plurality of home network elements 120a-120o. The home network elements (e.g., home network elements 120a-120o) may, for example, comprise one or more devices, systems, fixtures, appliances, and/or other circuitry. The home network elements (e.g., home network elements 120a-120o) may comprise, for example, one or more televisions 120a, one or more computers (e.g., laptop computer 120b, desktop computer 120c), one or more personal and/or handheld devices (e.g., tablet 120j, mobile phone 120k, smart watch 120m), one or more multimedia devices and/or components (e.g., speakers 120f), one or more structural fixtures (e.g., windows/window blinds 120d, smart watch), one or more lighting and/or electrical fixtures 120e, one or more appliances (e.g., refrigerator 120g), one or more environmental sensory devices 120h (e.g., thermometers, humidity meters), and/or one or more security devices 120i (e.g., a smoke detector, a carbon monoxide detector, a security alarm, a motion detector) one or more sensors and/or controllers (e.g., intelligent motion sensor 120l, RGBW controller 120n) and/or other devices (e.g., intelligent wall plug 120o).

The disclosure is not limited to any particular type of a home network. Furthermore, the disclosure is not limited to any particular combination of home network elements. It is to be understood that although the network is referred to as a “home network” throughout the disclosure, the disclosure is not limited in this way. Specifically, the network may comprise any other network that may be operable to control one or more network elements. For example, the network of the disclosure (whether or not referred to as a “home network”) may be implemented in a residential, non-residential, commercial, industrial and/or any other setting. Similarly, the network elements may comprise network elements (whether or not referred to as a “home network elements”) implemented in a residential, non-residential, commercial, industrial and/or any other setting.

In some instances, the home network 100 may incorporate a home network manager 110. The home network manager 110 may comprise suitable circuitry, interfaces, logic, and/or code for implementing various aspects of the present disclosure. For example, the home network manager 110 may be configured for use in managing, servicing, and/or interacting with one or more home network elements. Although the home network manager 110 is shown in FIG. 1 as a single and separate device, the disclosure is not limited in this way. For example, in some implementations, one or more functions of the home network manager 110 may be provided by one or more home network elements (e.g., providing user interface via tablet 120j and/or television 120a). In an example embodiment of the disclosure, the home network manager 110 may be implemented as a virtual platform, such as, for example, one or more software modules may run on, and/or utilize resources of one or more home network elements (e.g., laptop 120b, desktop 120c).

The home network manager 110 may be configured to communicate with one or more elements (e.g., home network devices, home network elements) in a home network. In an example embodiment of the disclosure, the home network manager 110 may be operable to communicate with one or more devices and/or systems that may be external to a home network, using, for example, optical, wired and/or wireless communication links.

Although the home network manager 110 is illustrated as a single device, the disclosure is not limited in this way. For example, the home network manager may comprise one or more home network manager that may each interact with one or more home network elements (e.g., home network elements 120a-120o). In an example embodiment of the disclosure, each of the one or more home network managers may be associated with particular one or more home network elements. In another example, one or more of the one or more home network managers may be associated with any one or more home network elements (e.g., home network elements within range of a particular home network manager, with best communication path).

In an example embodiment of the disclosure, the home network manager 110 may be implemented in an integrated or a distributed system. An integrated system may be implemented, for example, on one computer, server, machine or device, where the integrated system may be configured to perform some or all of the functions, features and/or operations of the home network manager 110 as described herein. A distributed system may be implemented with multiple components (e.g., computers, servers, machines and/or devices), where each of the multiple components may be configured to perform some or all of the functions, features and/or operations of the home network manager 110 as described herein. Each function, feature and/or operation may be implemented on one or more of the components of the distributed system. For example, a specific feature, function and/or operation may be implemented only one component of the distributed system or it may be implemented across multiple components of the distributed system.

In an example embodiment of the disclosure, in addition to or instead of the use of one or more home network managers, the home network 100 may comprise one or more master controllers for controlling one or more home network elements. A master controller may be pre-programmed and/or programmable to control one or more home network elements. A master controller may comprise, for example, a remote controller.

Although the disclosure may refer to a single home network manager, it is to be understood that the disclosure is not limited in this way. For example, the home network manager may comprise one or more home network managers that individually and/or in the aggregate may be implemented as integrated and/or a distributed system.

The home network manager 110 may interact with one or more of the home network elements 120a-120o via corresponding links 130a-130o, which may be supported by the home network manager 110 and/or the corresponding home network element(s). For example, the links 130a-130o may be implemented and/or configured to operate using a wireless protocol, such as, for example, a Z-wave protocol. In an example embodiment of the disclosure, the home network 100 may be implemented as Z-Wave network. However, the disclosure is not limited in this way. For example, the home network 110 may comprise one or more wired and/or wireless links and/or protocol. Wireless links and/or protocols, may comprise, for example, WPAN (e.g., Bluetooth or ZigBee), low power links (e.g., Bluetooth LE (BLE), Bluetooth Smart, iBeacon), near field communication protocols (e.g., NFC) and/or WLAN (WiFi/802.11) protocols and/or any other wireless links and/or protocols suitable for implementation consistent with the disclosure. Wired protocols and/or links may comprise, for example, Ethernet, Universal Serial Bus (USB), and/or any other wired links and/or protocols suitable for implementation consistent with the disclosure.

In an example embodiment of the disclosure, home network manager 110 may interact with one or more home network elements (e.g., home network elements) directly and/or indirectly. For example, the home network manager 110 may interact with one or more home network elements directly through a corresponding link (e.g., wireless, wired link/connection).

In another example, the home network manager 110 may interact with one or more home network elements indirectly though, for example, a converter (e.g., global cache). In this regard, the home network manager 110 that supports one or more particular network interfaces and/or other interfaces (e.g., USB) may be operable to interact with a particular network element (and/or another device) that may otherwise be incompatible with one or more of the one or more particular network and/or other interfaces supported by the home network manger 110. The interaction may be achieved though, for example, a converter and/or a translator. The converter and/or the translator may each comprise suitable logic, circuitry, interfaces, and/or code that may be operable to facilitate communication between a home network manager (e.g., the home network manger 110) and a home network element (home network elements 120a-120o).

In another example, the home network manager 110 may interact with one or more home network elements indirectly though, for example, other network elements. In this regard, the home network manager 110 may interact with one or more home network elements on, for example, a mesh network. An example mesh network (not shown) may facilitate communication (e.g., transmission of messages, signals, data frames) to and/or from the home network manager (e.g., the home network manager 110) to and/or from a particular network element where the communication may, for example, pass through one or more other network elements before reaching the particular network element and/or the home network manager.

In an example embodiment of the disclosure, the home network manager 110 may be operable to support one or more communication methods from one or more other home network devices (e.g., home network elements 120a-120o). For example, one or more home network elements may communicate with the home network manager 110 utilizing a particular wireless link and/or protocol (e.g., Z-wave) and/or a particular wired link and/or protocol (e.g., Ethernet), while one or more other home network elements may communicate with the home network manager 110 utilizing a different particular wireless link and/or protocol (e.g., WiFi) and/or a different particular wired link and/or protocol (e.g., USB).

In an example embodiment of the disclosure, the same one or more home network elements may communicate with the home network manager 110 by, for example, using one or more wired and/or wireless links and/or protocols at the same and/or at different times. For example, a particular network element may communicate with the home network manager 110 using a Z-Wave communication protocol for a particular communication and may communicate with the home network manager 110 using a WiFi communication protocol for another particular communication.

In an example embodiment of the disclosure, one or more home network elements (e.g., home network elements 120a-120o) may communicate with one or more home network elements (e.g., home network elements 120a-120o) directly. In this regard, the one or more network elements may utilize one or more communication links (e.g., wireless, wired) (not shown) and/or one or more network interfaces and/or other interfaces without directing (e.g., routing the communication thought, for example, a home network manager (e.g., the home network manger 110). For example, a home network element may be operable to detect existence of one or more other network elements (e.g., on the same and/or different network) and may initiate, send and/or receive communication to and/or from the one or more other network elements.

In an example embodiment of the disclosure, one network element may be out of range of a home network manager and may communicate with one or more other network elements to determine whether the one or more other network elements are within range of a particular (e.g., a home network manager previously within range of the one network element) and/or any network manager. The range detection and/or discovery may continue from one network element to another. For example, a particular home network element may need to communicate through more than one other home network element in order to, for example, communicate with a desired home network element and/or a desired, particular and/or any home network manager (e.g., the home network manager 110). The disclosure is not limited to a communication for a purpose of range discovery/detection. The communication may comprise any type of communication and may be used for a variety of other purposes (e.g., communicating with a different network element, communicating with a home network manager, controlling an out of range device, controlling another network element).

In an example embodiment of the disclosure, one or more home network elements (e.g., home networks elements 120a-120o) may be operable to control one or more other home network elements (e.g., home networks elements 120a-120o) with and/or without intermediary, such as, for example, a home network manager (e.g., home network manager). For example, one or more home network elements may be operable to control one or more other home network elements through an intermediary. In this regard, a particular network element may communicate with an intermediary (e.g., home network manager) in order to communicate with and/or to control another home networks element. An intermediary may comprise one or more devices (e.g., a preprogrammed and/or programmable master controller, home network manager) that may be operable to control one or more network elements. In another example, a particular network element may directly communicate with and/or to control another home networks element.

In an example embodiment of the disclosure, one or more home network elements (e.g. home network elements 120a-120o) and/or other devices that may be operable to communicate on the network (and/or an associated network as described herewith) and/or that may not be operable to communicate on the network but may otherwise be tractable (e.g., GPS, iBeacon, electronic tag), with one or more other network elements, devices and/or a network manager (e.g., home network manager 110) associated with a particular network (e.g., home network 100) (and/or an associated network as described herewith), may communicate with each other, other devices (e.g., on the same network, another network and/or otherwise connected and/or tractable) and/or the network manager, and/or may be operable to determine a precise location of a particular network element, device and/or network manager utilizing various communication protocols and/or interfaces.

For example, one or more network elements (and/or other devices operable on the network, an associated network as described herewith and/or otherwise traceable) may be operable to generate and/or receive information and/or one more signals and/or messages that may be utilized in determining a location of a particular network element, device and/or network manager. In this regard, a near field communication and/or a low power interface protocol (e.g., BLE, iBeacon) may be utilized for communication between the elements, devices and/or network managers. Furthermore, one more tags (e.g., small electronic devices) may be utilized, to facilitate location of particular elements, devices and/or network managers. For example, a network element, device and/or home network manager may generate a signal and/or a message (on the network, on an associated network and/or through a built in, external, portable and/or otherwise attachable tag) that may be received by another network element, device and/or network manager.

In an example embodiment of the disclosure, one or more home network elements, devices and/or manager may cooperate (e.g., exchange information) to, for example, collectively and/or individually determine a precise location of a particular network elements, device and/or network manager based on the received one or more signals and/or messages. As an example only, a particular network element, device and/or home network manager may generate a signal and/or a message that may be received by other network element, device and/or home network device within a particular time frame. The information about the time it took to, for example, receive the particular one or more signals and/or messages (and/or the information gather from the one or more signals and/or messages, such as, for example, signal strength) may be used to determine the precise location (e.g., distance to/from the network element, device, network manager that received the particular one or more signals and/or message) of the particular network element, device and/or network manager.

In operation, the home network manager 110 may be operable to manage a home network (e.g., the home network 100). The home network manager 110 may be utilized, for example, as an interface platform for interacting with various network elements (e.g., the home network elements 120a-120o). In this regard, the home network manager 110 may support establishing and/or configuring one or more communication connections/links (e.g., the links 130a-130o) with the one or more elements of the home network 110. Once established, the connectivity between the home network manager 110 and the home network elements (e.g., network elements 120a-120o) may, for example, be utilized to enable centralized monitoring, control, and/or management of the home network elements, and/or of the home network 100 as a whole. For example, the home network manager 110 may be operable to control operations of certain elements (e.g., turn on television 120a, switch to particular channel(s) at particular days/times, and/or record if recording is supported); monitor environment in the home network, such as by obtaining environmental readings (e.g., temperature, humidity, etc.) via example environmental sensory devices 120h, and may process these readings (e.g., to determine if/when to adjust other home network elements accordingly); adjust one or more example lighting and/or electrical fixtures 120e (e.g., turn lights on or off); lower/raise example window blinds 120d; adjust operations of example appliances (e.g., refrigerator 120g), such as, for example, based on a preconfigured power efficiency/optimization profile; monitor for any indications of a security/safety problem, based on, for example, input from example security devices 120i, and/or act accordingly (e.g., send notifications to users, such as by texting example smartphone 120k, and/or automatically notify authorities, e.g., by dialing ‘911’ and/or contacting preconfigured emergency numbers).

In an example embodiment of the disclosure, the home network manager 110 may provide and/or utilize user interface services in the home network. In this regard, the home network manager 110 may be operable to support use of user interface functions, and/or to generate and/or store information corresponding thereto, which may be utilized to enable interactions between the home network manager 110 and users (e.g., in the home network 100). For example, in some implementations, the home network manager 110 may be configured to generate and/or use a graphic user interface (GUI), for visually displaying information and/or providing interactivity with users (e.g., for providing input thereby). One or more user interfaces may enable configuring the home network manager 110 and/or functions provided by the home network manager 110. In an example embodiment of the disclosure, the one or more user interfaces may enable user interaction with, configuring and/or adjusting other elements in the home network 100 (e.g., elements connected to the home network manager 110).

In an example embodiment of the disclosure, the user interfaces may be provided via one or more other devices that may be communicatively coupled to the home network manager 110. For example, a GUI generated and/or used by the home network manager 110 may be displayed using existing home network elements, such as, for example, television 120a, laptop 120b, tablet 120j, and/or smartphone 120k.

The disclosure is not limited to a single network (e.g., home network 100) and/or a single network manager (e.g., home network manager 110). For example, one or more networks (e.g., home network 100) and/or one or more network managers (e.g., home network manager 110) may be grouped together. The grouping may correspond to one or more locations (e.g., location 101).

In an example embodiment of the disclosure, a network (e.g., home network 100) may be associated with one or more network managers (e.g., home network manager 110). For example, one network manager may be associated with one or more networks (e.g., home network 100) and/or locations (e.g., location 101),

In an example embodiment of the disclosure, a grouping of networks may comprise one or more network, network managers and/or locations. The grouping may be programmable and/or configurable. For example, one more networks may be defined, one or more network managers may be assigned per network and/or associated with one or more devices with a network and/or a network manager. In this regard, the information may be shared between the different networks, network managers and/or devices assigned to the different networks and/or network managers. For example, information gathered on one network (e.g., by a network device, through an occurrence of a condition, event, an alarm, and/or other predefined and/or preconfigured condition) may cause the information to be communicated on the same and/or another associated network. In this regard, the information may trigger a condition, an alarm, an occurrence of an event and/or any other predefined and/or preconfigured condition (e.g., operation of a device, network element) on the same and/or another associated network.

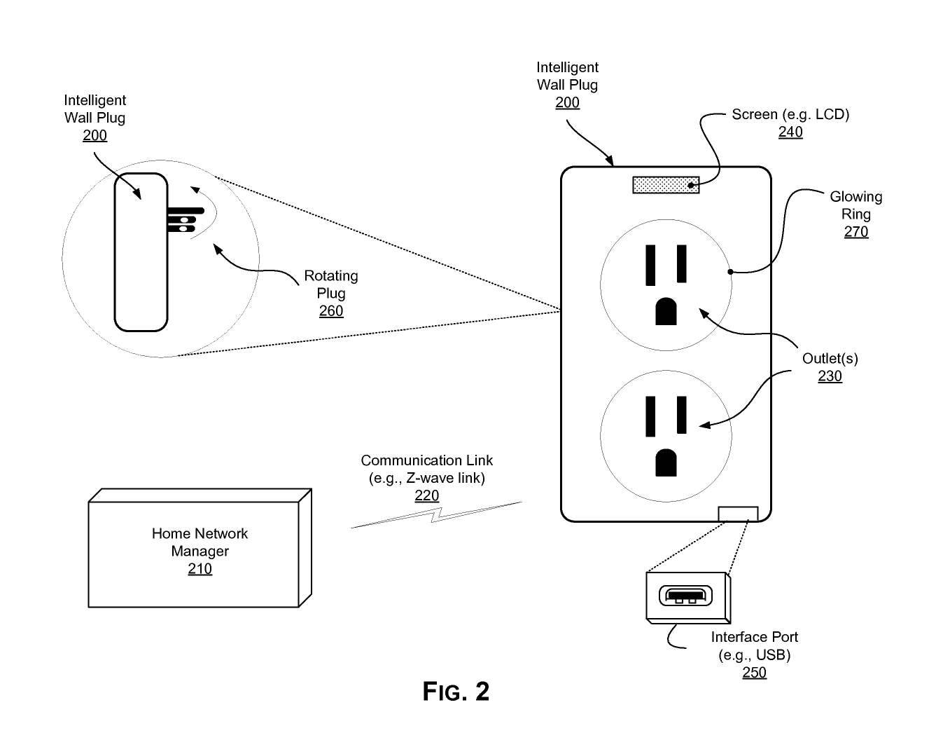

In an example embodiment of the disclosure, one or more home network elements (e.g., home network elements 120a-120o) may be configured to provide enhanced functionality, especially in the context of the home network provided by home network managers (e.g., the home network manager 110). For example, in addition to utilizing a typical wall plug, an enhanced (intelligent) wall plug may be utilized, such as to provide enhanced power supply monitoring functions, device interface functions and/or other functions in a home network (e.g., the home network 100). An example intelligent wall plug is depicted in and/or described with respect to FIG. 2.

FIG. 2 illustrates an example intelligent wall plug. Referring to FIG. 2, there is shown an intelligent wall plug 200.

The intelligent wall plug 200 may comprise suitable circuitry, interfaces, logic, and/or code for implementing various aspects of the present disclosure. The intelligent wall plug 200 may be implemented and/or configured to provide enhanced power supply, device control and/or related functions.

The intelligent wall plug 200 may be utilized as a wall plug adapter. For example, the intelligent wall plug 200 may be operable to be plugged into, for example, an existing power outlet using, for example a plug (e.g., rotating plug 260). In this regard the intelligent wall plug 200 may derive power from the existing power outlet in order to, for example, provide enhanced functionality (e.g., power supply, control) to one or more devices that may in turn be plugged into the intelligent wall plug 200. The plug that may be utilized for connecting the intelligent wall plug 200 into an existing power outlet may be rotational such that the intelligent wall plug 200 may, for example, be easily fitted into any existing power outlet and/or power strip, etc.

In an example embodiment of the disclosure, the intelligent wall plug 200 may be operable to support providing power supply, such as via one or more receptacles (e.g., outlet(s) 230 and interface port(s) 250), in which devices may be plugged to derive electric power (e.g., directly or indirectly from an electric grid). Although the intelligent wall plug 200 is depicted with two outlets 230, the discourse is not limited in this way. For example, the intelligent wall plug 200 may comprise one or more outlet(s) (e.g., outlet(s) 230) that may support providing power to one or more electronic devices under one or more power standards, for example, as may be required by international or national regulatory organizations.

In another example embodiment of the disclosure, the intelligent wall plug 200 may be operable to provide functionality consistent with the disclosure while operating on battery power. For example, the intelligent wall plug 200 may comprise a built-in and/or replaceable or rechargeable battery (not shown) that may support the operation of the intelligent wall plug 200 during, for example, a power outage and/or to provide functionality when, for example, the intelligent wall plug 200 is intentionally and/or unintentionally unplugged from a standard power outlet.

For example, during a power outage the intelligent wall plug 200 may be operable to support its communication functions, with for example, a network manager (e.g., home network manager 210). In this regard, the intelligent wall plug 200 may be able to communicate to the network manager information that may indicate that, for example, a power outage occurred and/or that one or more network devices (plugged into and/or otherwise connected to the intelligent wall plug 200) may not be operable.

The intelligent wall plug 200 may be configured for operation on a home network (e.g., home network 100 as depicted in and/or described with respect to FIG. 1), such that, the intelligent wall plug 200 may be utilized as a home network element. In this regard, the intelligent wall plug 200 may be configured to interact or communicate, for example, in a home network (e.g., home network 100 as depicted in and/or described with respect to FIG. 1) with, for example, a home network manager (e.g., home network manager 210). The home network manager may be substantially similar to the home network manager 110 as depicted in and/or described with respect to FIG. 1.

For example, the intelligent wall plug 200 may be configured to communicate with the home network manager 210 via, for example, a communication link 220. The communication link 220 may, for example, comprise a Z-Wave link. The disclosure is not limited to any particular type of a communication link. For example, the intelligent wall plug 200 may be implemented to support, for example one or more wireless and/or wired links, protocols and/or connections. For example, wireless links, protocols and/or connections, may comprise, for example, WPAN (e.g., Bluetooth or ZigBee) and/or WLAN (WiFi/802.11) protocols and/or any other wireless links, protocols and/or connections suitable for implementation consistent with the disclosure. Wired links, protocols and/or connections may comprise, for example, Ethernet, Universal Serial Bus (USB), and/or any other wired links, protocols and/or connections suitable for implementation consistent with the disclosure. While not shown in FIG. 2, to support communication with other elements or systems, such as the home network manager 210, the intelligent wall plug 200 may incorporate a communication transceiver (e.g., a Z-Wave transceiver) and/or related processing resources for allowing use of the intelligent wall plug 200. In en example embodiment of the disclosure, the intelligent wall plug 200 may comprise an internal and/or an external antenna for communicating with other devices (e.g., devices on the network, network elements 120a-120o, home network manager 210).

In an example embodiment of the disclosure, the intelligent wall plug 200 may provide wired and/or wireless interfaces that may enable one or more network devices to connect to a home network (e.g., home network 100) and/or home network manager (e.g., home network manager 210).

The intelligent wall plug 200 may incorporate various features for providing enhanced power supply related functions and/or operations. In this regard, the intelligent wall plug 200 may be designed and/or configured to perform as an extremely compact, intelligent and/or sophisticated, remotely controlled outlet adapter. The intelligent wall plug 200 may be operable to allow control, such as by other systems (e.g., the home network manager 210), of power operations provided by the intelligent wall plug 200. For example, the intelligent wall plug 200 may allow the home network manager 210 to control and/or monitor, using, for example, the connection link 220, electrical devices (e.g., refrigerator 120g) which may be plugged into the outlet(s) 230 or the interface port 250 of the intelligent wall plug 200.

In an example embodiment of the disclosure, the intelligent wall plug 200 may be designed and/or configured to provide power metering function(s). In this regard, the intelligent wall plug 200 may incorporate suitable components (e.g., circuitry) for monitoring power consumption (e.g., of devices drawing power through the intelligent wall plug 200). The intelligent wall plug 200 may, for example, be applied at particular sections of the home network to allow control of electrical devices, and may monitor and/or track power consumption in a convenient and maintenance-free manner.

In an example embodiment of the disclosure, the intelligent wall plug 200 may monitor power consumption and/or other criteria associated with one or more outlets (e.g., outlet(s) 230) individually and/or in the aggregate, after a device has been plugged into or connected to one or more of the receptacles. In an example embodiment of the disclosure, the intelligent wall plug 200 may be operable to initiate an alert condition or an alarm signal when, for example, power consumption associated with the one/or more outlets (individually and/or in the aggregate) or consumed by the connected device exceeds a pre-defined and/or pre-configured level.

In an example embodiment of the disclosure, the intelligent wall plug 200 may be configured to provide real-time indication of power consumption. For example, the intelligent wall plug 200 may incorporate means (e.g., LEDs) for indicating power consumption in visual manner—e.g., one or more parts of intelligent wall plug 200 (and/or the whole intelligent wall plug 200) may glow (e.g., using LEDs) in different colors depending on power consumption. For example, the intelligent wall plug 200 may glow green to indicate low power consumption. In another example, the intelligent wall plug 200 may glow red to indicate high power consumption.

In another example embodiment of the disclosure, visual indication of the power consumption may be provided for each of the one or more receptacles (e.g., outlet(s) 230 and interface port 250) individually. For example, the intelligent wall plug 200 may be operable to glow in one or more colors in one or more areas that may surround a particular outlet (e.g., a glowing ring around the particular outlet, illumination of the outlet part) to indicate power consumption associated with the particular outlet of the one or more outlets.

For example, the intelligent wall plug 200 may comprise one or more glowing rings (e.g., glowing ring 270) that may be associated with each of the one or more receptacles (e.g., outlet(s) 230 and interface port 250). A glowing ring (e.g., glowing ring 270) may comprise, for example one or more LEDs (or other light emitting devices) that may be situated on the inside and/or on the outside of a casing of the intelligent wall plug 200. In one example, the casing (and/or parts thereof) of the intelligent wall plug 200 may be partially and/or wholly transparent. In this regard, the glowing ring (e.g., glowing ring 270) may glow different colors depending on, for example, the power consumption, such that the glowing ring will be visible on the outside of the intelligent wall plug and/or through the partially and/or wholly transparent casing. Although the glowing rings 270 are depicted to surround the receptacles (e.g., outlet(s) 230 and interface port 250), the interface port 250 may also include a surrounding glowing ring to display similar power consumption information.

In an example embodiment of the disclosure, the power consumption monitoring may comprise collecting power consumption related information. The power consumption information may comprise, for example, data pertaining to power consumption (e.g., current and/or aggregate), and/or additional information, such as, for example, information regarding the device(s) (e.g., type of device, make/model, etc.) that may be plugged into the intelligent wall plug 200.

In an example embodiment of the disclosure, the power consumption related information may, for example, be reported by the intelligent wall plug 200 to an external device. For example, the information may be communicated to a home network manager (e.g., home network manager 210). The home network manager may, for example, utilize the information to manage the home network and/or adjust operations of various elements of the home network. In an example embodiment of the disclosure, the intelligent wall plug 200 may incorporate means for enabling reporting of the information directly, for example, through a user interface on the intelligent wall plug 200. For example, in an example embodiment of the disclosure, the intelligent wall plug 200 may incorporate a screen (e.g., LCD screen) 240, which may be situated in the casing (e.g., top side, bottom, side) of the intelligent wall plug 200.

The example screen may be utilized to display various information, including, for example, the current power consumption (e.g., by individual outlets, consumption in the aggregate), and/or information such as, for example, information regarding connected device(s), connectivity (e.g., within the home network, within a range of a home network manager) related information, etc. For example, intelligent wall plug 200 may be operable to display (e.g., on the screen 240) the power consumption information for each of the one or more outlets (e.g., outlet(s) 230), each of the one or more interface ports (e.g., interface port 250), and/or in aggregate between any two or more of the one or more outlets and/or interface ports. The mode of display may, for example, comprise displaying information about current (“live”) power consumption and/or aggregate power consumption (e.g., over a day, week, month, year and/or any other pre-defined and/or pre-configured time interval). The aggregate power consumption information (e.g., over a pre-defined and/or pre-configured time interval) may be displayed for each individual outlet and/or interface port and/or a sum of power consumption statistics across one or more outlets (e.g., outlet(s) 230) and/or interface ports (e.g., interface port 250).

In an example embodiment of the disclosure, the mode of display may be control by a user using one or more input/output devices associated with the intelligent wall plug 200 and/or through an outside interface, such as, for example, an interface provided by a network manager (e.g., network manager 210). For example, a button may be provided, that may be located on the casing of the intelligent wall plug 200, that may be operable to change the display mode of the intelligent wall plug 200. In this regard, a user may be able to press the button (e.g., a pre-determined number of times) to adjust the display mode of the intelligent wall plug 200. The present disclosure is not limited to any particular mode of display and/or mode of operating and/or adjusting the mode of display. Accordingly, the intelligent wall plug 200 may comprise other suitable modes of operation and/or adjustment of the display mode consistent with the disclosure.

In an example embodiment of the disclosure, the intelligent wall plug 200 may comprise one or more input/output (“I/O”) interfaces. The I/O interface may comprise suitable logic, circuitry, interfaces, and/or code that may be operable to enable user interactions with the intelligent wall plug 200 through interfaces other than, for example, the example button, consistent with the disclosure. The I/O interface may, obtain input from user(s) of the intelligent wall plug 200 and/or provide output to the user(s). The I/O interface may support various types of inputs and/or outputs, including, for example, video, audio, and/or textual. In this regard, dedicated I/O devices and/or components, external to or integrated within the intelligent wall plug 200, may be utilized for inputting and/or outputting data during operations of the I/O interface. Exemplary (external or integrated) I/O devices may comprise displays, mice, keyboards, touchscreens, voice input interfaces, and other input/output interfaces or devices.

In an example embodiment, the intelligent wall plug 200 may incorporate one or more interface ports, such as, for example, the interface port 250. The one or more interface ports may be situated in the casing (e.g., top, bottom, side) of the intelligent wall plug 200. Although the disclosure may reference a single interface port (e.g., interface port 250), the disclosure is not limited in this way. For example, the intelligent wall plug 200 may comprise one or more same or different interface ports (not shown).

The interface port 250 may be utilized to provide power to the intelligent wall plug 200, such as to drive various circuitry used in various functions of the intelligent wall plug 200 (e.g., communicative functions, monitoring functions, display functions). The interface port may be utilized to charge a built-in and/or a replaceable battery, if include, (not shown) of the intelligent wall plug 200. The interface port 250 may, for example, comprise a USB, FireWire and/or another interface adapter for use consistent with the disclosure. In an example embodiment of the disclosure, the interface port 250 may be utilized to provide power supply to a device that may be connected to the intelligent wall plug 200 thought the interface port 250.

In an example embodiment of the disclosure, the one or more interface ports may be utilized to monitor power consumption and/or other criteria associated with one or more interface ports (e.g., interface port 250) individually and/or in the aggregate. In an example embodiment of the disclosure, the intelligent wall plug 200 may be operable to initiate an alert condition when, for example, power consumption associated with the one/or more interface ports (individually and/or in the aggregate) exceeds a pre-defined and/or pre-configured level.

In an example embodiment of the disclosure, the interface port 250 may be utilized, for example, in supporting control of devices plugged into and/or otherwise connected to the intelligent wall plug 200. For example, the interface port 250 may be operable to enable control of devices that may not otherwise be compatible (e.g., may not be operable to directly connect to the home network and/or the home network manager) with a home network (e.g., home network 100) on which the intelligent home plug 200 operates and/or a home network manager (e.g., home network manager 210).

The disclosure is not limited to providing support only to incompatible devices. For example, the intelligent wall plug 250 may provide support to any device that may or may not be otherwise compatible with a home network on which the intelligent wall plug 250 operates. For example, it may be desirable to utilize the wall plug 250 as both a charging unit and/or an interface unit. In this regard, the intelligent wall plug 200 may, for example, provide charging functionality and/or control functionality to a device connected to the intelligent wall plug 200. In this regard, the connected device may not need to utilize its interfaces that may otherwise be operable for connecting with the home network (and/or a home network manager) on which the intelligent plug 200 and/or the connected device may operate.

In an example embodiment of the disclosure, the outlets 230 and the interface port 250 may allow devices (e.g., once plugged in) to communicate with a home network manager (e.g., home network manager 210) by providing one or more translator and/or direct control functions. For example, a home network manager (e.g., home network manager 210) may be operable to control a device that may be plugged be connected to the intelligent wall plug 250 through, for example, the interface port 250. In this regard, the intelligent wall plug 200 may interact with the connected device over the interface port 250 and/or may allow the connected device (that may or may not be otherwise incompatible) to communicate with the network manager by, for example, translating data communications (e.g., messages) to and/or from either the network manager and/or the connected device. For example, the intelligent wall plug may translate the communication between a protocol that the connected device may support and/or a communication protocol that may be supported by the home manager to, for example, communicate with the intelligent wall plug 250 (e.g., Z-Wave). For another example, the devices may be originally configured to communicate using a particular device communication protocol that is not compatible with the network communication protocol used by the home network. In such cases, the translator may translate signals transmitted from the home network manager using the network communication protocol into signals that may be transmitted using the particular device communication protocol. In this way, the device may receive the transmitted signals, for example, control signals, and use the received signals to control operations and/or functions of the plugged device. Similarly, the plugged device may also transmit signals, such as, for example, operational information using the device communication protocol. In such cases, the translator may also translate the signals into signals that can be transmitted using the network communication protocol. Thus, the home network manager may be able to monitor and/or log the operational information of the plugged device.

In an example embodiment of the disclosure, the intelligent wall plug 200 may provide other wired and/or wireless interfaces that may enable one or more devices to connect to a home network (e.g., home network 100) and/or home network manager (e.g., home network manager 210). For example, if the network manager provides connectivity of various devices to a home network, for example, based on a Z-Wave protocol, the intelligent wall plug 200 may, for example, contain suitable circuitry, interfaces, logic, and/or code that may enable a particular device that, for example, may not be compatible with the example Z-Wave protocol (and/or any other particular protocol that the network manager supports) to connect to the network manager and/or the home network.

In an example embodiment of the disclosure, the intelligent wall plug 200 may be operable to communicate with a network manager (e.g., home network manager 210). The intelligent wall plug 200 may communicate, to the network manager, information and/or data relating to, for example, status of the intelligent wall plug 200 and/or any devices that may be plugged into the intelligent wall plug 200 and/or otherwise connected with the intelligent wall plug 200 (e.g., devices plugged into the one or more outlets(s) 230 and/or one or more interface ports, such as, for example, the interface port 250). The communications may comprise status information, alarm conditions and/or any other information that may be relevant to the operation of the intelligent wall plug 200, the devices that may be plugged in to the intelligent wall plug 200 and/or any other information that may be relevant to the operation of a home network. The status and/or alarm conditions may comprise status and/or alarm conditions associated with power consumption monitoring in one or more of the outlets (e.g., outlet(s) 230) and/or one or more interface ports (e.g., interface port 250).

In an example embodiment of the disclosure, the intelligent wall plug 200 may also receive communications from the network manager. The communications may, for example, comprise information relating to alarm conditions and/or information comprising commands that may be executed on the intelligent wall plug 200 (e.g., disconnecting power supply to one or more outlets and/or interface port, for example, in response, to an alarm condition).

In an example embodiment of the disclosure, the intelligent wall plug 200 may incorporate a wireless range tester (not shown) that may be operable to, for example, determine whether the intelligent wall plug 200 is within a range of a home network manager (e.g., home network manager 210) and/or other network element. In this regard, the intelligent wall plug 200 may be operable to generate an alarm condition when the intelligent wall plug 200 is not within a rage on any home network manager (e.g., home network manager 210) and/or other network element and/or when the intelligent wall plug 200 that, for example, was previously within the range of a (e.g., home network manager 210) and/or other network element, is now outside of that range. In an example embodiment of the disclosure, the alarm condition may active one or more alarm indicators to generate indicate an alarm condition by, for example, generating an audible and/or a visual alarm.

In another example embodiment of the disclosure, the home network manager 210 may be operable to generate an alarm condition, when for example, the intelligent wall plug that, for example, was previously within the range of the home network manager 210, is now outside of that range.

In another example embodiment of the disclosure, wireless range tester may indicate whether the intelligent wall plug 200 is in range, is in an intermediate range and/or is out of range of a home network manager, if the intelligent wall plug 200 communicates wirelessly. The in range indication may, for example, be associated with a condition where the intelligent wall plug 200 may establish a direct connection with a home network manager (e.g., home network manager 210) and whether or not a direct communication is desirable (e.g., the intelligent wall plug 200 may, for example, communicate with the home network manager utilizing other network elements although a direct communication would be possible). The in an intermediate range condition may, for example, be associated with a condition where the intelligent wall plug 200 may not establish a direct connection with a home network manager (e.g., the home network manager 210) but may establish an indirect communication with the home network manager (e.g., through other network elements). The out of range indication may, for example be associated with a condition where the intelligent wall plug 200 may not be able to establish either a direct and/or in direct communication with a home network manager (e.g., the home network manager 210).

In an example embodiment of the disclosure, the intelligent wall plug 200 may indicate whether the intelligent wall plug 200 is in range (e.g., direct, indirect) and/or out of range through one or more audio and/or visual indicators. The indicators may be, for example, integrated with and/or external to the intelligent wall plug 200. For example, the intelligent wall plug 200 may comprise an external visual indicator (e.g., LED, RGB, RGBW light) that may be operable to display the status of the intelligent wall plug 200 with respect to the range through different colors and/or illumination schemes. For example, a visual indicator may display a different color depending on the in-range status (e.g., one color may indicate that the intelligent wall plug 200 is in a direct range, a second color may indicate that the intelligent wall plug 200 is in indirect range and/or a third color may indicate that the intelligent wall plug 200 is out of range). In another example, the visual indicator may blink at different frequencies, illuminate without blinking and/or be operable to display different illumination schemes depending on the in-range status of the video gateway device.

In an example embodiment of the disclosure, the intelligent wall plug 200 may comprise other suitable circuitry, interfaces, logic, and/or code for implementing various aspects of the present disclosure. For example, the intelligent wall plug 200 may comprise a memory and/or a processor.

The memory may store, for example, configuration data, which may comprise parameters and/or code, comprising software and/or firmware. The memory may comprise different memory technologies, including, for example, read-only memory (ROM), electrically erasable programmable ROM (EEPROM), random access memory (RAM), low latency nonvolatile memory, flash memory, solid-state drive (SSD), field-programmable gate array (FPGA), and/or other suitable electronic data storage capable of storing data, code and/or other information.

In an example embodiment of the disclosure, the intelligent wall plug 200 may be operable to receive software and/or firmware updates. For example, the intelligent wall plug 200 may receive software and/or firmware updates from a network manager (e.g., the home network manager 210). In an example embodiment of the disclosure the software and/or hardware updates may be received, processed and/or installed automatically and/or manually. For example, the process may be completely automatic (e.g., a network manager may send an update to the intelligent wall plug and the intelligent wall plug may process it automatically), semi-automatic (e.g., an update may be initiated by a user through, for example, a network manager and/or through an interface on the intelligent wall plug, and may, for example, be processed by the intelligent wall plug automatically) and/or manual (e.g., an update may be initiated by a user through, for example, a network manager and/or through an interface on the intelligent wall plug, and may, for example, be processed by the intelligent wall plug in response to a user action indicative of a desire to install the particular update (e.g., through an interface)).

The processor may comprise suitable circuitry, interfaces, logic, and/or code that may be operable to process data, and/or control and/or manage components, operations and/or functions of the intelligent wall plug 200, and/or tasks performed therein. In this regard, the processor may configure and/or control operations of various components and/or subsystems of the intelligent wall plug 200, such as, for example, the memory, the communication subsystem (e.g., for communicating with, for example, the home network manager 210), the outlet(s) 230, the screen 240 and/or the interface port 250, etc. by utilizing, one or more control signals.

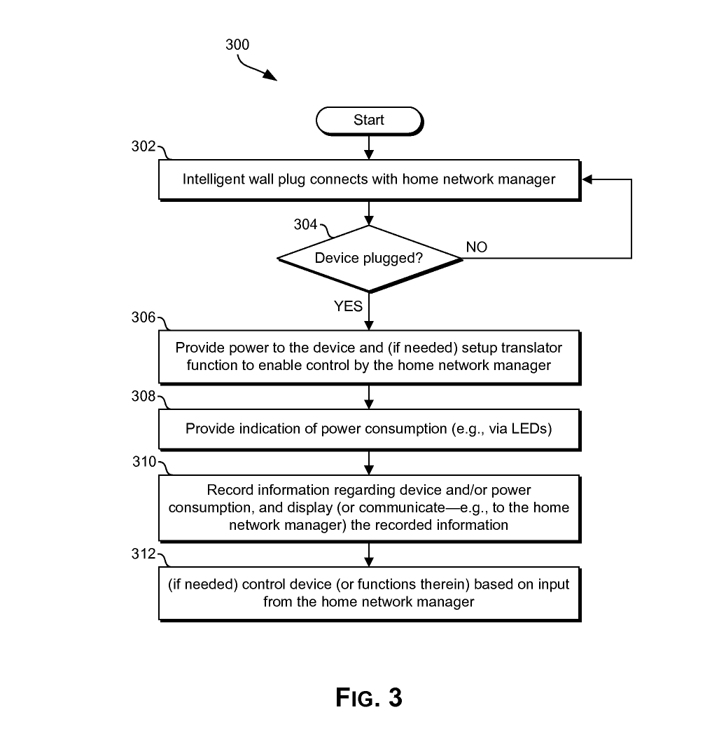

FIG. 3 illustrates an example flow chart of a method for an example process for managing one or more intelligent wall plugs. Referring to FIG. 3, there is shown a flow chart 300 comprising a plurality of example steps.

In example step 302, an intelligent wall plug (e.g., the intelligent wall plug 200 as depicted in and/or described with respect to FIG. 2) may connect with a home network manager (e.g., the home network manager 210 as depicted in and/or described with respect to FIG. 2). The connection may comprise a communication link (e.g., the communication link 220 as depicted in and/or described with respect to FIG. 2), such as, for example, a Z-Wave link. The connection may comprise one or more types of wireless and/or wired connections. The connecting may, in some instances, comprise determining whether the intelligent wall plug is within range of the home network manager. In this regard, the intelligent wall plug may incorporate a wireless range tester for determining whether the intelligent wall plug is within a range of a home network manager as described with respect to FIG. 2, for example.

In example step 304, it may be determined whether a device has been plugged into the intelligent wall plug. The device may be plugged into the intelligent plug through one or more of the receptacles, for example, an outlet (e.g., outlet(s) 230) and/or an interface port (e.g., interface port 250). In instances where no device is plugged in, the process may loop back to the example step 302. In instances where a device is plugged, however, the process may proceed to example step 306.

In example step 306, the intelligent wall plug may provide power to the plugged device (e.g., via outlet(s) 230, interface port 250). In some instances, if needed (e.g., where the device may be incompatible with the home network or the home network manager and/or where, for example, it may be desirable to indirectly control an otherwise compatible device through the intelligent wall plug), a translator function for enabling control by the home network manager of the plugged in (and/or otherwise connected) device may be setup in the intelligent wall plug (e.g., using an interface port), as described with respect to FIG. 2, for example.

In example step 308, the intelligent wall plug may provide indication of power consumption, such as in the form of visual indication (via LEDs), as described with respect to FIG. 2, for example.

In example step 310, information regarding the plugged device and/or the power consumption (e.g., current and/or aggregate) may be recorded. The recorded information may then be reported. In this regard, the information may displayed directly by the intelligent wall plug (e.g., via a LCD screen) and/or may be communicated to other systems (e.g., the home network manager, through communication links between it and the intelligent wall plug). In an example embodiment of the disclosure, the recordation step may be optional and/or the information may be communicated directly either to an interface component of the intelligent wall plug (e.g., for displaying on an LCD screen) and/or for communication outside of the intelligent wall plug (e.g., to network manager).

In example step 312, the plugged device (or functions therein) may be controlled, through the intelligent wall plug (including by use of translator function if needed), for example, based on input from the home network manager.

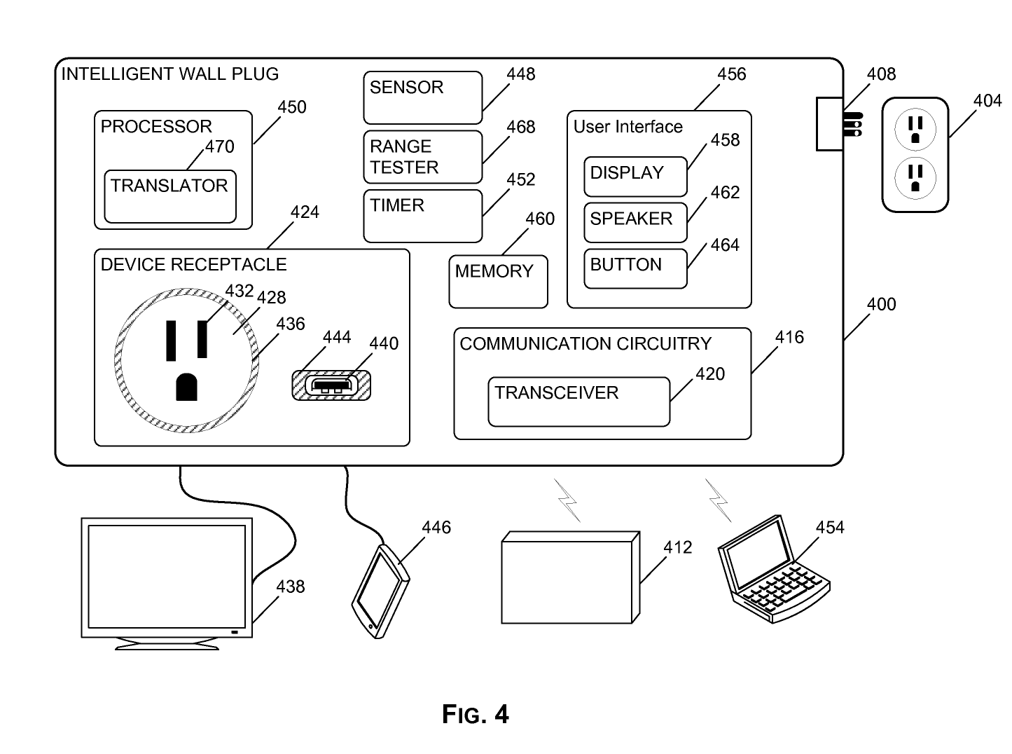

FIG. 4 illustrates an intelligent control system 400 for use with an electrical outlet 404 of a location similar to the location 101 of FIG. 1. In the embodiment shown, the intelligent control system 400 includes a rotatable plug or set of prongs 408 that may be rotatably and/or removably inserted or connected to the electrical outlet 404. The intelligent control system 400 also includes a network manager 412 similar to the home network manager 110 of FIG. 1, that manages one or more devices (for example, devices 120a-120k of FIG. 1) registered with a network, similar to the home network 100 of FIG. 1. In some embodiments, the network manager 412 communicates via a first communication protocol, such as, for example, a z-wave communication protocol. In this regard, the intelligent control system 400 also includes communication circuitry 416, which further includes a transceiver 420, for communicating signals to/from the network manager 412.

The intelligent control system 400 also includes a device receptacle 424 for removably connecting to one or more devices. In the embodiment shown, the device receptacle 424 further includes a second electrical outlet 428. The second electrical outlet 428 includes a plurality of prong receptacles 432 for receiving two-pronged devices (not shown) or three-pronged devices (not shown). The second electrical outlet 428 is also surrounded by a RGB or glowing ring 436 similar to the glowing ring 270 of FIG. 2. In some embodiments, the glowing ring 436 may inform a user about a current load and/or power consumption of a connected device (not shown) by visually changing the color of the glowing ring 436. For example, when the connected device has not been activated, the color of the glowing ring 436 may be aqua-blue indicative of no or minimum load, yellow or orange indicative of moderate load (for example, about 500 W), and red or purple indicative of very heavy load (for example, over 2500 W). For example, a TV 438 when connected to the second electrical outlet 428 may draw 500 W during usage, and thus the glowing ring 436 may turn from aqua-blue to blue. For another example, the glowing ring 436 may turn to bright yellow when a hair dryer (not shown) is used. For yet another example, the glowing ring 436 may turn to purple when an electric hear (not shown) is activated. For still another example, the glowing ring 436 may turn to flashing purple when an electric boiler (not shown) is being used.

Similarly, the device receptacle 424 may also include a universal-serial-bus (USB) receptacle 440 to receive a male USB plug (not shown). The USB receptacle 440 may also include an optional glowing ring 444 to indicate a current load and/or power consumption drawn by an attached USB device (not shown). For example, a smartphone 446 may only turn the glowing ring 436 to dark aqua-blue when the smartphone is connected to the USB receptacle 440. In some cases, the USB receptacle 440 may be used a charger for smart devices.

In this regard, the intelligent control system 400 may also include a sensor 448, for example, a thermal sensor, to sense an operating temperature of the intelligent control system 400, for example, while a device is plugged into the device receptacle 424. In the event that the operating temperature rises above a predetermined threshold, a processor 450 may terminate supplying power to the connected device. Similarly, the intelligent control system 400 may also include a timer 452 to time an amount of time that a device has been consuming power. For example, when the timer 452 has measured that a device has been consuming power for a period of time, and the processor 450 determines that the period of time has reached or exceeded a pre-determined amount of time, the processor 450 may also terminate supplying power to the connected device. Alternatively, when the processor 450 determines that the period of time has reached or exceeded a pre-determined amount of time, the processor 450 may send a signal via the communication circuitry to a laptop 454 or any other pre-configured devices connected to the network manager 412 to indicate that the pre-determined amount of time has elapsed since the connected device has been used. In such cases, a user of the laptop 454 or the other pre-configured devices connected to the network manager 412 may terminate supplying power to the connected device. In this regard, the user may terminate supplying power to the connected device directly by sending a corresponding termination signal from the laptop 454 or the other pre-configured devices connected to the intelligent control system 400. Alternatively, the user may terminate supplying power to the connected device indirectly by sending a terminal command (not shown) to the network manager 412, and the network manager 412 in turns sends a termination signal to the intelligent control system 400. In response to receiving the termination signal, whether directly or indirectly, the processor 450 terminate supplying power to the connected device. This feature is especially useful, for example, for parental control of gaming device usages.

The intelligent control system 400 may also include a user interface 456 allowing a user to interact with the intelligent control system 400, in addition to the glowing rings 436 and 444 as discussed above. For example, the user interface 456 may also include one or more additional displays 458 to display information, such as, for example, power consumed by a connected device. In some embodiments, the power consumed by a connected device may be stored in a memory 460. In some embodiments, information and/or data indicative of the power consumed by the connected device may also be communicated from the intelligent control system 400 through the communication circuitry 416 directly to a pre-configured device of the network, such as, for example, the laptop 454, or indirectly to the network manager 412, and then to the pre-configured device of the network, such as, for example, the laptop 454. Thus, a user of the pre-configured device of the network, such as, for example, the laptop 454 may have real-time access of the information and/or data related to the power consumption.

The user interface 456 may also optionally include a speaker 462 to sound an alarm, for example, when the connected device is malfunctioning In such cases, the intelligent control system 400 may also terminate supplying power to the connected device, and communicate the malfunctioning to the network manager 412 and/or directly to the pre-configured device of the network, such as, for example, the laptop 454.

In some embodiments, the user interface 456 may also optionally include a network button 464, when activated, allowing a user of the intelligent control system 400 to wirelessly connect to the network and/or the network manager 412. After the intelligent control system 400 has been connected to the network manager 412, a user may program one or more operational scene for a device that is connected to the intelligent control system 400. For example, as discussed above, a user may program the network manager 412 to terminate supplying power to a connected device when a timer has reached a pre-configured amount of time. For another example, also as discussed above, a user may also program the intelligent control system 400 to report a power consumption of a connected device to one or more pre-defined devices, for example, the laptop 454. For still another example, also as discussed above, a user may also program the intelligent control system 400 to report a fault and/or malfunctioning of a connected device to one or more pre-defined devices, for example, the laptop 454. More specifically, the intelligent control system 400 may also include a network range tester 468 for testing coverage of the network, for example, an intelligent Z-Wave network. When the network button 464 is activated, for example, for a pre-defined period of time, the display 458 may be lit to a certain color to indicate a satisfactory coverage, and a different color to indicate insufficient coverage.

In some embodiments, when a device to be connected to the intelligent control system 400 does not communicate using the first communication protocol used by the network manager 412, for example, a second communication protocol, the intelligent control system 400 may include a translator 470 to translate between the first communication protocol and the second communication protocol. For example, when the network manager 412 communicates a signal in the first communication protocol, the translator 470 may translate the signal in the first communication protocol to a signal in the second communication protocol so as to allow the connected device to receive.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for an intelligent wall plug.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. An intelligent wall plug being removably connectable to an electrical outlet and for use with a remote wireless manager configured to communicate via a first communication protocol, the intelligent wall plug comprising:
a device receptacle configured to receive a device operable to communicate in a second communication protocol; and
a processor coupled to the device receptacle, and configured to receive control signals from said remote wireless manager via said first communication protocol, to determine if a device has been connected to said device receptacle, and, in response to having determined that a device having been connected to said device receptacle, to translate the first communication protocol into the second communication protocol, and to control said device with said communicated control signals.

2. An intelligent wall plug of claim 1, wherein the device receptacle comprises at least one of a universal-serial-bus (USB) receptacle and a second electrical outlet.

3. An intelligent wall plug of claim 1, further comprising a rotatable plug configured to removably connect said intelligent wall plug to said electrical outlet.

4. An intelligent wall plug of claim 1, wherein said first communication protocol includes z-wave communication protocol.

5. An intelligent wall plug of claim 1, wherein said processor, in response to having determined that a device having been connected to said device receptacle, is further configured to monitor a power consumption of said connected device.

6. An intelligent wall plug of claim 5, wherein said processor is further configured to determine if said power consumption exceeds a pre-configured level, and, in response to determining that said power consumption having exceeded the pre-configured level, to send out an alarm signal indicative of said power consumption.

7. An intelligent wall plug of claim 5, further comprising a ring configured to display at least one of a plurality of colors indicative of said power consumption.

8. An intelligent control system for use with an electrical outlet, the system comprising:
a device configured to communicate in a first communication protocol;
a network manager operable to communicate control signals to said device via a second communication protocol; and
an intelligent wall plug being removably connectable to the electrical outlet, and having
a) a receptacle,
b) a processor configured to receive said control signal via said second communication protocol, and
c) a translator, in response to said device having been connected to said receptacle, configured to
i) translate said second communication protocol into said first communication protocol, and
ii) communicate said control signals to said connected device via said first communication protocol to control said device.

9. An intelligent control system of claim 8, wherein the receptacle comprises at least one of a universal-serial-bus (USB) receptacle and a second electrical outlet.

10. An intelligent control system of claim 8, wherein the intelligent wall plug further comprises a rotatable plug configured to removably connect said intelligent wall plug to said electrical outlet.

11. An intelligent control system of claim 8, wherein said second communication protocol includes z-wave communication protocol.

12. An intelligent control system of claim 8, wherein said processor, in response to said device having been connected to said receptacle, is further configured to monitor a power consumption of said connected device.

13. An intelligent control system of claim 12, wherein said processor is further configured to determine if said power consumption exceeds a pre-configured level, and, in response to determining that said power consumption having exceeded the pre-configured level, to send out an alarm signal indicative of said power consumption.

14. An intelligent control system of claim 8, wherein said intelligent wall plug further comprises a ring configured to display at least one of a plurality of colors indicative of said power consumption.

15. A method of controlling a remote device via an intelligent wall plug being removably connectable to an electrical outlet, said remote device being operable to communicate in a first communication protocol with a network manager operable to communicate control signals via a second communication protocol, the method comprising:
determining if the remote device has been connected to the intelligent wall plug;
translating, in response to said device having been connected to said intelligent wall plug, said second communication protocol into said first communication protocol;
communicating said control signals to said connected remote device via said first communication protocol; and
controlling said connected remote device with said control signals.

16. A method of controlling a remote device of claim 15, wherein the intelligent wall plug comprises at least one of a universal-serial-bus (USB) receptacle and a second electrical outlet.

17. A method of controlling a remote device of claim 15, wherein the intelligent wall plug comprises a rotatable plug configured to removably connect said intelligent wall plug to said electrical outlet.

18. A method of controlling a remote device of claim 18, wherein said second communication protocol includes z-wave communication protocol.

19. A method of controlling a remote device of claim 15, further comprising monitoring, in response to said remote connected device having been connected to said intelligent wall plug, a power consumption of said connected device.

20. A method of controlling a remote device of claim 18, wherein said intelligent wall plug further comprises a ring, the method further comprising:
displaying on said ring at least one of a plurality of colors indicative of said power consumption;
determining if said power consumption exceeds a pre-configured level; and
sending, in response to determining that said power consumption having exceeded the pre-configured level, an alarm signal indicative of said power consumption.
